(19) United States
(12) Patent Application Publication
(10) Pub. No.: US 2024/0056222 A1
(43) Pub. Date: Feb. 15, 2024

(54) METHOD FOR COLLABORATIVELY DECODING A CORRUPTED FRAME DETECTED BY SEVERAL BASE STATIONS WHILST OPTIMISING THE ACCESS NETWORK LOAD

(71) Applicant: UNABIZ, LABEGE (FR)

(72) Inventors: Juan Carlos ZUNIGA, Montreal, Quebec (CA); Arnaud MANSUY, TOULOUSE (FR); Renaud MARTY, RAMONVILLE SAINT AGNE (FR)

(21) Appl. No.: 18/258,175

(22) PCT Filed: Dec. 16, 2021
(86) PCT No.: PCT/EP2021/086157

§ 371 Date: Jun. 16, 2023

(30) Foreign Application Priority Data
Dec. 18, 2020 (FR) FR2013636

(51) Int. Cl. H04L 1/02; H04B 7/022

(52) U.S. Cl. CPC H04L 1/02; H04B 7/022

(57) ABSTRACT

In a wireless communication system, there is disclosed a method for decoding a frame transmitted by a transmitter device is executed by a receiver device. The method includes the following steps:—selecting one or more gateway stations likely to have detected, on a communication channel, a corrupted frame corresponding to the frame to be decoded, the selection being carried out such that, in order to be selected, a gateway station does not have communicate beforehand, to the receiver device, any item of information relating to the possibly detected corrupted frame in order;—sending a request to each selected gateway station in order to request the selected gateway station to transmit the possibly detected corrupted frame; and—combining the corrupted frames transmitted by the various selected gateway stations in order to decode the frame.

### FIELD OF THE INVENTION

The present invention relates to the field of wireless communication systems. In particular, the invention relates to a method for collaboratively decoding a frame transmitted by a terminal and detected simultaneously by several base stations.

### PRIOR ART

Spatial diversity is known to be used in wireless communication systems to improve performance when decoding a frame transmitted by a transmitter.

Spatial diversity can be used, in particular, when several receivers located at different positions each detect a corrupted frame corresponding to the frame transmitted by the transmitter, without it being possible to decode said frame from a single corrupted frame detected by a receiver. The various corrupted frames detected by the various receivers should thus be combined to try and decode the frame transmitted by the transmitter.

Several methods based on the concept of spatial diversity exist. These methods are typically based on MIMO (Multiple-Input Multiple Output) and MRC (Maximal-Ratio Combining) technologies.

Conventionally, in MRC technology, all of the receivers that have detected a frame send the detected frame to a central server responsible for combining the various detected frames in order to decode the frame transmitted by the transmitter. However, this decoding method places a significant load on the access network, in particular in terms of the bandwidth of the communication link connecting the server with the base stations, and in terms of the server's computing capacity.

In an incremental version of MRC technology (I-MRC, which stands for “Incremental-MRC”), rather than unconditionally sending the detected frame, each receiver that has detected a frame corresponding to the frame to be decoded sends the server an item of information relating to a level of radio quality of the detected frame (for example, a signal-to-noise ratio level for the detected frame). The server can thus place the receivers in descending order of the level of radio quality of the detected frame, then iteratively request that each receiver, in the order thus defined, transmit the frame detected by said receiver to the server, as long as the server is unable to decode the frame from the detected frames already received. However, this decoding method requires numerous communication exchanges between the server and the various receivers that have detected a frame corresponding to the frame to be decoded.

Patent KR 101 511 782 B1 describes various implementations of a method for collaboratively decoding a frame transmitted by a source node to a destination node and relayed by various relay stations. Several relays are selected depending on the frame they have transmitted, and collaborative decoding is carried out on the basis of the frames received from the various selected relays.

The document “A cloud-optimized link layer for low-power wide-area networks”, by Artur Balanuta et al, describes a method for correcting a corrupted frame based on several versions of the frame received by various base stations of a low-speed access network.

No satisfactory solution currently exists, in particular in terms of the load on the access network, for collaboratively decoding a frame transmitted by a transmitter based on several corrupted frames detected respectively by several receivers located at different positions.

### DISCLOSURE OF THE INVENTION

The purpose of the present invention is to overcome all or part of the drawbacks of the prior art, in particular those described hereinabove.

To this end, and according to a first aspect, the present invention proposes a method for decoding a frame transmitted by a transmitter device of a wireless communication system when said frame can be received simultaneously by several gateway stations of said wireless communication system. The method is implemented by a receiver device connected to the gateway stations. The method comprises the following steps of:
selecting one or more gateway stations likely to have detected, on a communication channel, a corrupted frame corresponding to the frame to be decoded, said selection being carried out such that, in order to be selected, a gateway station does not have to communicate beforehand, to the receiver device, any item of information relating to the possibly detected corrupted frame,
transmitting a request to each selected gateway station in order to request said selected gateway station to transmit the possibly detected corrupted frame,
combining the corrupted frames transmitted by the various selected gateway stations in order to decode the frame.

For example, a frame is considered to have been “corrupted” when the receiver device is unable to decode said frame from a single version of the frame detected and transmitted by a gateway station. Other versions of said frame that were possibly detected by other gateway stations must thus be obtained and the different versions obtained must be combined in order to decode the frame transmitted by the transmitter device. According to another example, a frame is considered to have been “corrupted” when the receiver device does not receive an expected frame that should have been received on the communication channel at a given moment in time. Different versions of said frame that were possibly detected by certain gateway stations must thus be obtained in order to decode said frame by combining the different versions obtained. This is referred to as “collaborative” decoding because decoding is based on the combination of several versions of the frame respectively detected by various gateway stations, whereas each version taken individually does not allow the frame to be decoded.

In the method according to the invention, only some gateway stations likely to have detected the frame transmitted by the transmitter device are selected to take part in the collaborative decoding of the frame by the receiver device. Such provisions allow, on the one hand, the number of communication exchanges between the receiver device and the gateway stations to be limited, and allow the number of frames to be analysed and possibly combined by the receiver device to also be limited (which reduces the required computing capacity of the receiver device).

As will be described in more detail hereinbelow, various methods can be used to select gateway stations that are likely to have detected the frame transmitted by the transmitter device. It should be noted, however, that this selection is carried out without a gateway station being required to have previously communicated, to the receiver device, an item of information relating to the corrupted frame that it has possibly detected. This is understood to mean that a gateway station is not required to have transmitted the frame, or even an item of information relating to a power level at which the frame was detected, before the selection is made. Once again, such provisions allow the load on the communication system to be limited, in particular in terms of the bandwidth of the communication link connecting the receiver device with the gateway stations.

The communication channel is defined, for example, by a time period and/or a frequency band in which the frame is transmitted by the transmitter device to the receiver device.

The request can be transmitted to each selected gateway station by multicast or broadcast or by unicast.

The purpose of the request transmitted to each selected gateway station is to request said selected gateway station to transmit, for the first time, the possibly detected corrupted frame. More specifically, this request is transmitted at a moment in time when the frame has not already been transmitted by the gateway station to which the request is sent.

According to a first example, the transmitter device corresponds to a terminal of the communication system, a gateway station corresponds to a base station of an access network of said communication system, and the receiver device corresponds to a server of said access network. The server is responsible for decoding a frame transmitted by the terminal to the access network.

According to a second example, a gateway station is a repeater-type relay station. For example, this could be an AF-type repeater (which stands for “Amplify and Forward”, where the signal is simply amplified for retransmission) or a DF-type repeater (which stands for “Decode and Forward”, where the signal is demodulated and then remodulated for retransmission). The transmitter device can be a terminal and the receiver device can be an entity of an access network to which the frame transmitted by the terminal is sent. Conversely, the transmitter device can be a base station of an access network and the receiver device can be a terminal to which the frame transmitted by the base station is sent.

In specific implementations, the invention can further comprise one or more of the following features, considered singly or according to any technically-feasible combination.

In specific implementations, the method comprises a prior step of receiving a corrupted frame detected on said communication channel by a first gateway station. Said first gateway station is configured to transmit a corrupted frame when a predetermined criterion is satisfied.

The criterion can relate to a level of radio quality (for example the value of a signal-to-noise ratio of the signal carrying the frame on the communication channel), to a sequence number (for example if a corrupted frame is received between two frames with non-consecutive sequence numbers), or to an identifier of the transmitter device (for example if it is detected that the corrupted frame was transmitted by a transmitter device attributed with high importance), etc.

In specific implementations, the predetermined criterion for the transmission of the corrupted frame by the first gateway station is satisfied when a level of radio quality for at least part of the corrupted frame is greater than a predetermined threshold.

In specific implementations, the step of selecting a gateway station likely to have detected a corrupted frame corresponding to the frame to be decoded comprises calculating a distance between said gateway station and the first gateway station.

In specific implementations, the step of selecting a gateway station likely to have detected a corrupted frame corresponding to the frame to be decoded comprises comparing the distance between said gateway station and the first gateway station with a predetermined threshold.

In specific implementations, the step of selecting a gateway station likely to have detected a corrupted frame corresponding to the frame to be decoded is implemented by a machine learning algorithm based on a probability for said gateway station of having detected a corrupted frame corresponding to the frame to be decoded, knowing the first gateway station.

In specific implementations, the method comprises a prior step of determining that an expected frame should have been received on the communication channel.

In specific implementations, the step of selecting a gateway station likely to have detected a corrupted frame corresponding to the frame to be decoded comprises checking whether said gateway station is located in a predetermined geographical area corresponding to an estimated geographical position of the transmitter device that transmitted the frame to be decoded.

In specific implementations, in response to the request from the receiver device, only part of the corrupted frame is transmitted by a selected gateway station, and the receiver device combines the parts of the corrupted frames transmitted by the various selected gateway stations in order to decode the frame.

In specific implementations, several requests intended for the same selected gateway station, to request said selected gateway station to transmit several different corrupted frames that may have been received, are concatenated and transmitted by the receiver device all at once in a single request message.

In specific implementations, in response to several requests transmitted by the receiver device for several different frames, several corrupted frames are concatenated and transmitted all at once by a selected gateway station.

According to a second aspect, the present invention relates to a computer program product comprising a set of program code instructions which, when executed by one or more processors, configure the one or more processors to implement a method according to any one of the implementations of the method according to the invention.

According to a second aspect, the present invention relates to a server of an access network of a wireless communication system. The server is connected to several base stations of said access network and is configured to decode a frame transmitted by a terminal of said wireless communication system. The server comprises one or more processors configured to implement a method according to any one of the implementations of the method according to the invention.

According to a second aspect, the present invention relates to an access network of a wireless communication system, said access network comprising a server according to any one of the embodiments of the invention.

### PRESENTATION OF THE FIGS

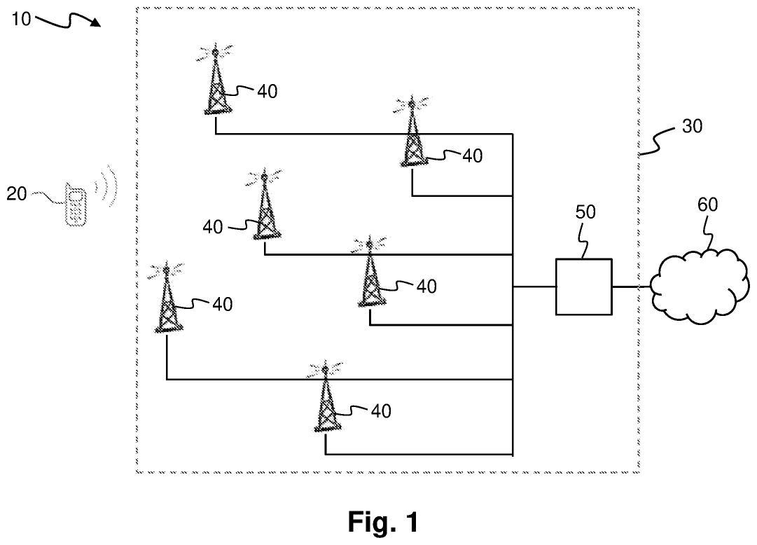

The invention will be better understood upon reading the following description, given as a non-limiting example, and made with reference to FIGS. 1 to 7 which show:

FIG. 1 a diagrammatic view of a wireless communication system,

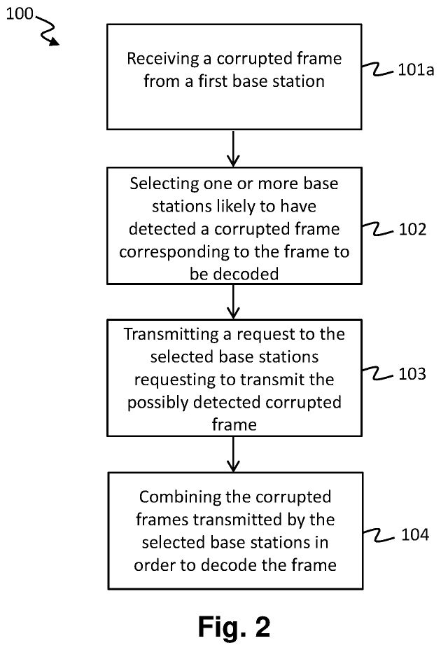

FIG. 2 a diagrammatic view of the main steps of a first implementation of the decoding method according to the invention,

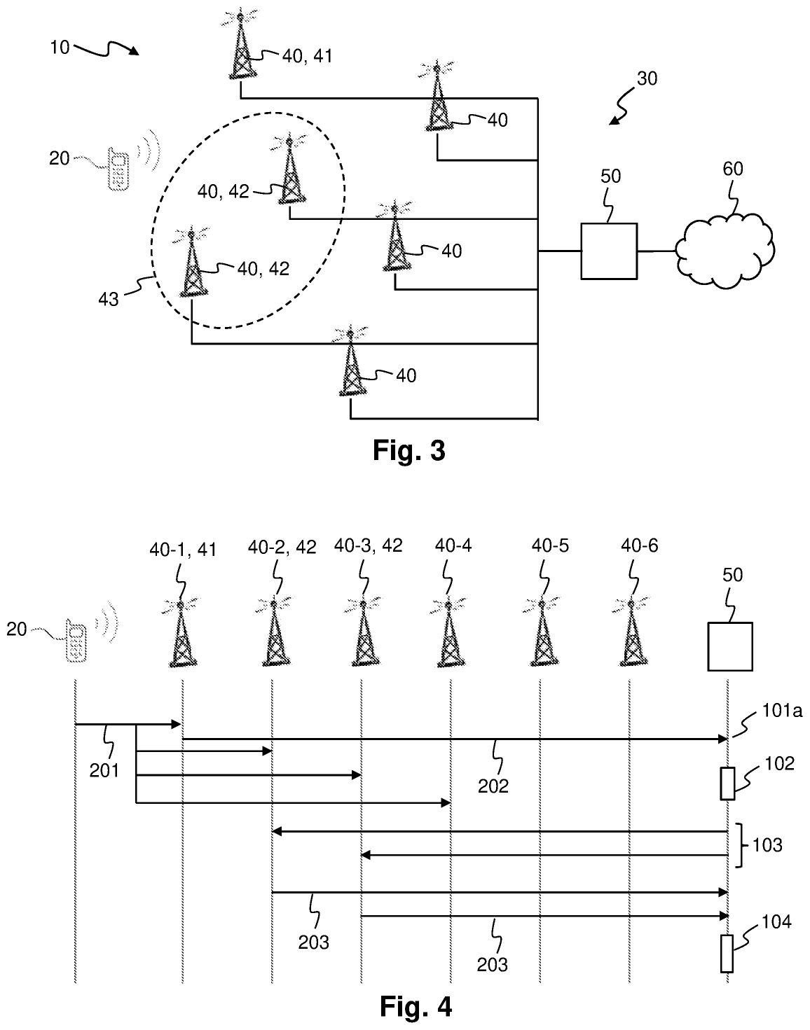

FIG. 3 an illustration of the first implementation of the decoding method by the access network,

FIG. 4 a sequence chart illustrating the first implementation of the decoding method,

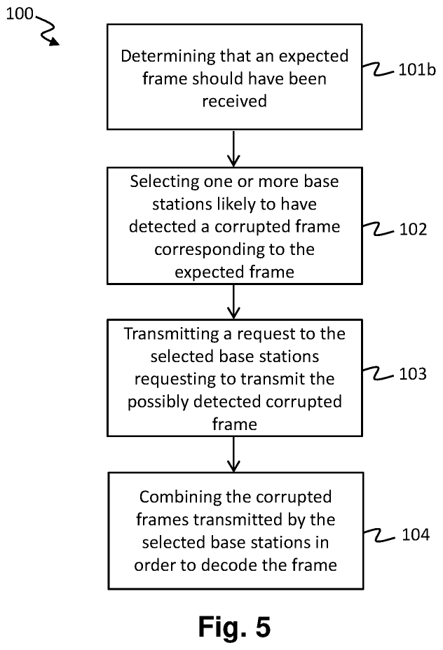

FIG. 5 a diagrammatic view of the main steps of a second implementation of the decoding method according to the invention,

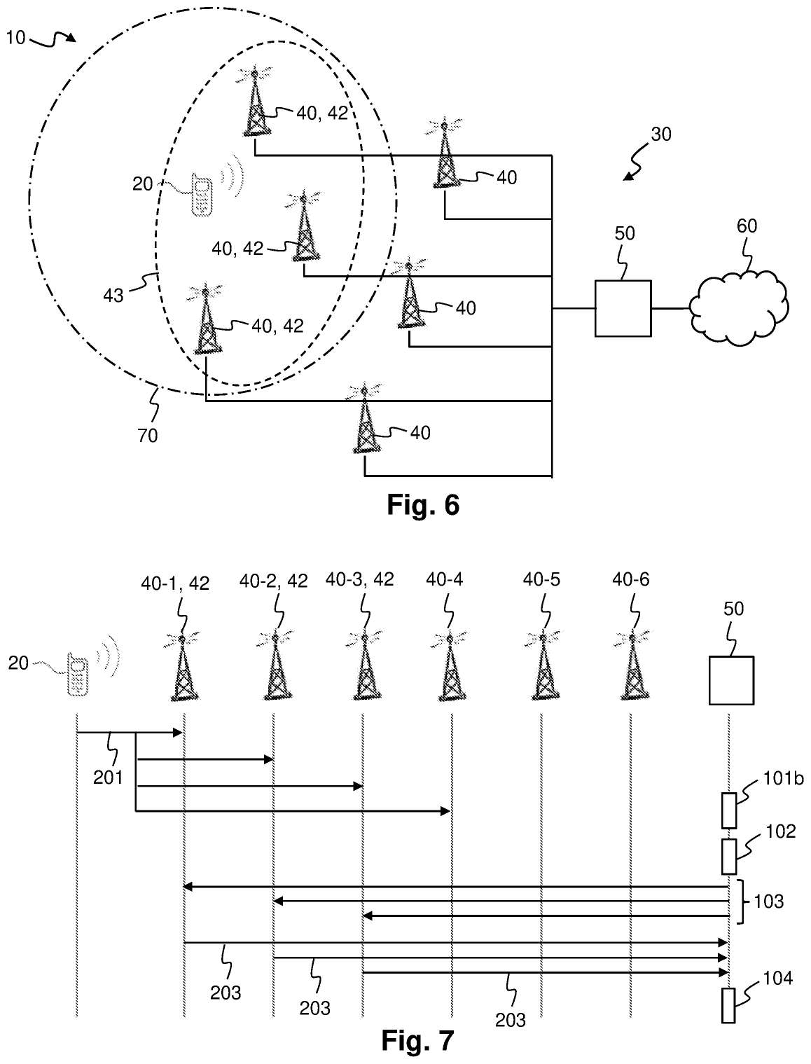

FIG. 6 an illustration of the second implementation of the decoding method by the access network,

FIG. 7 a sequence chart illustrating the second implementation of the decoding method,

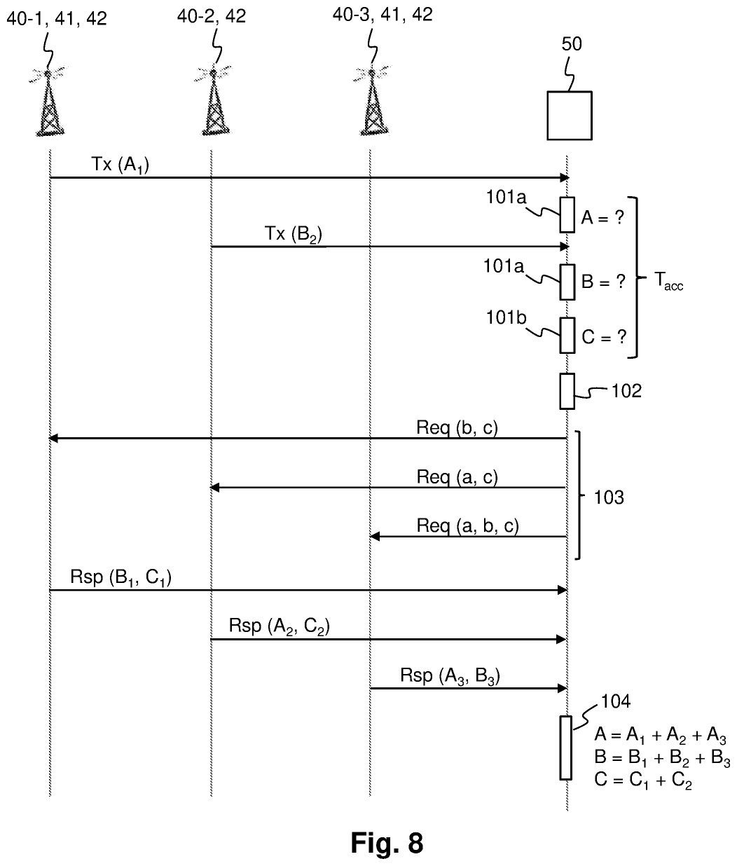

FIG. 8 a sequence chart illustrating a scenario wherein the server 50 accumulates several requests to be transmitted to various base stations over an accumulation period,

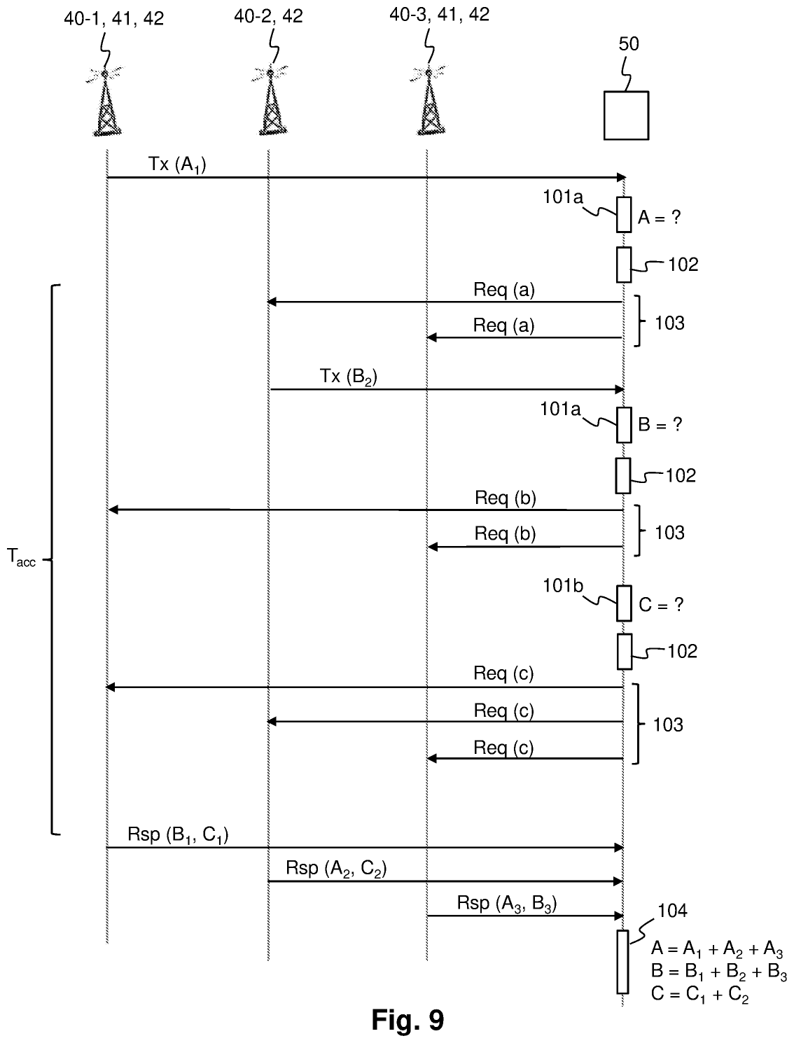

FIG. 9 a sequence chart illustrating a scenario wherein the base stations accumulate, over an accumulation period, several individual requests successively transmitted by the server for several frames to be decoded.

In these figures, identical references from one figure to another refer to identical or similar elements. For clarity, the represented elements are not necessarily plotted to the same scale, unless stated otherwise.

### DETAILED DESCRIPTION OF AN EMBODIMENT OF THE INVENTION

The present invention is particularly advantageous in the case of a wireless communication system for applications of the M2M (Machine-to-Machine) type, or of the IoT (Internet of Things) type, although it is not limited thereto.

In such a wireless communication system, the data exchanges are essentially monodirectional, in this instance over an uplink from the terminals to an access network of said system. In order to minimise the risks of losing a frame (a message) transmitted by a terminal, the access network is often planned such that a given geographical area is simultaneously covered by several base stations, such that a frame transmitted by a terminal can be received by several base stations of the access network. This is understood to mean that the same frame transmitted by a terminal can be received and processed by several base stations (and not just by a single base station with which the terminal is associated).

FIG. 1 diagrammatically shows one example of such a wireless communication system 10. The wireless communication system 10 comprises terminals 20 and an access network 30 comprising base stations 40 and a server 50. The base stations 40 are connected to the server 50 by wired or wireless communication links. The access network 30 is connected to a backbone network 60, such as the Internet for example.

In the example considered, the terminal 20 thus acts as the transmitter device, a base station acts as a gateway station, and the server acts as the receiver device responsible for decoding the frame transmitted by the terminal.

Each base station 40 is suitable for receiving frames from a terminal 20 that is located within range thereof. A frame transmitted by a terminal 20 can in particular comprise a terminal identifier enabling said terminal 20 to be identified. Each frame thus received is, for example, transmitted to the server 50 of the access network 30, potentially accompanied by other information such as an identifier for the base station 40 that received it, a value representative of the quality of the radio signal carrying the frame, the centre frequency over which the frame was received, and a date at which the frame was received, etc. The server 50 can thus process all of the frames received from the various base stations 40. In particular, the server 50 can be responsible for decoding a frame detected by a base station 40.

The wireless communication system 10 is, for example, a Low Power Wide Area Network (LPWAN). Such a wireless communication system is a long-range access network (greater than one kilometre, or even greater than several tens of kilometres), with low power consumption (for example, a power consumption during transmission or reception of a frame of less than 100 mW, or less than 50 mW, or even less than 25 mW), and with speeds generally below 1 Mbps. Such wireless communication systems are particularly suitable for applications involving connected objects.

In specific implementations, the wireless communication system 10 can be an ultra-narrowband communication system. The term “ultra-narrowband” or UNB is understood herein to mean that the instantaneous frequency spectrum of the radio signals transmitted by the terminals has a frequency bandwidth of less than two kilohertz, or even of less than one kilohertz. Such a system significantly reduces the power consumption of the terminals while they are communicating with the access network.

The detection of a frame at a base station 40 corresponds, for example, to the detection of a synchronisation pattern indicating the start of a frame. The synchronisation pattern corresponds, for example, to a set of predefined radio symbols. The detection of a frame can further comprise identifying certain control parameters of the frame, such as an identifier of the terminal that transmitted the frame, or a sequence number of the frame, etc.

Decoding a frame, however, requires the ability to decode all of the data contained in the frame (not just the control data, but also the payload data). This decoding can be implemented by the server 50.

Sometimes, a frame transmitted by a terminal 20 and detected by a base station 40 cannot be decoded, for example because the signal carrying the frame has suffered interference and/or the level of radio quality of the signal is too low to allow the frame to be decoded correctly and in full. In such a case, and assuming that several base stations 40 located at different positions have also detected a corrupted frame corresponding to the frame transmitted by the transmitter, the frame can be collaboratively decoded using spatial diversity. In particular, the various corrupted frames detected by the various base stations can be combined to try and decode the frame transmitted by the terminal 20.

Various methods exist based on the concept of spatial diversity and the combination of various corrupted frames (or portions of corrupted frames) received by various receivers, in order to completely decode an expected frame. These methods are typically based on MIMO or MRC technologies. These conventional methods are considered to be known to those skilled in the art. The choice of a specific method for combining several corrupted frames merely constitutes an alternative implementation of the invention.

The heart of the invention, however, lies in a specific method for collecting the various corrupted frames to be combined. The method according to the invention aims in particular to limit the load on the access network 30, i.e. to limit the exchanges between the base stations 40 and the server 50 to decode a frame.

The server 50 can in particular be used to implement the main steps of the decoding method according to the invention. To this end, the server 50 comprises a processing circuit comprising one or more processors and storage means (magnetic hard drive, electronic memory, optical disc, etc.) in which a computer program product is stored, in the form of a set of program code instructions to be executed in order to implement the steps of the decoding method. Alternatively or additionally, the processing circuit of the server 50 comprises one or more programmable logic devices (FPGA, PLD, etc.), and/or one or more application-specific integrated circuits (ASIC), and/or a set of discrete electronic components, etc., suitable for implementing the steps of the decoding method. In other words, the server 50 comprises software and/or hardware means for implementing the decoding method according to the invention.

FIG. 2 diagrammatically shows the main steps of a first implementation of the decoding method 100 according to the invention. FIG. 3 illustrates one example implementation by the access network 30.

The method 100 firstly comprises a step 101a wherein the server 50 receives a corrupted frame transmitted by the terminal 20 and detected by a first base station 41 on a communication channel. The communication channel is defined, for example, by a time period and a frequency band in which the frame is transmitted by the terminal to the access network.

The method 100 then comprises a step 102 wherein the server 50 selects one or more base stations 42 likely to have detected, on said communication channel, a corrupted frame corresponding to the frame to be decoded. However, the selection step 102 is carried out in such a way that, in order to be selected, a base station 42 is not required to have previously communicated, to the server 50, any item of information relating to said possibly detected corrupted frame. This is understood to mean that a base station 42 is not required to have transmitted the frame, or even, for example, an item of information relating to a power level at which the frame was detected, before the selection 102 is made.

The method 100 then comprises a step 103 wherein the server 50 transmits a request to each selected base station 42 to request that said selected base station 42 transmit the possibly detected corrupted frame. The purpose of this request is to request said selected base station 42 to transmit the possibly detected corrupted frame for the first time (this request is transmitted at a moment in time when the frame has not already been transmitted by the selected base station 42).

The request 103 can be transmitted to each selected base station 42 by multicast or broadcast or by unicast. The request can, in particular, comprise information about the frame (for example the frequency or time period at which the frame is assumed to have been transmitted, an assumed sequence number of the frame, or an identifier of the terminal assumed to have transmitted the frame, etc.).

Finally, the server combines 104 the corrupted frames transmitted by the various selected base stations 42 in order to decode the frame.

In the figures, the reference numeral 40 typically represents a base station of the access network 30; the reference numeral 41 represents the first base station involved in step 101a; and the reference numeral 42 represents the base stations selected in step 102 and involved in step 103.

Thus, only some base stations 42 likely to have detected the frame transmitted by the terminal 20 are selected to take part in the collaborative decoding of the frame by the server 50. The set 43 of selected base stations 42 is shown in FIG. 3 by the dotted region.

Such provisions allow, on the one hand, the number of communication exchanges between the server and the base stations of the access network to be limited (which limits the load on the access network), and allow the number of frames to be analysed and possibly combined by the server to also be limited (which reduces the required computing capacity of the server). It is important to note that the selection step 102 is carried out without a base station 42 being required to have previously communicated, to the server, an item of information relating to the corrupted frame that it has possibly detected.

The first base station 41 can be configured to transmit a corrupted frame when a predetermined criterion is satisfied. The criterion can relate to a level of radio quality (for example the value of a signal-to-noise ratio of the signal carrying the frame on the communication channel). The predetermined criterion for the transmission of the corrupted frame by the first base station 41 can in particular be considered to have been satisfied when a level of radio quality for at least part of the corrupted frame is greater than a predetermined threshold. Such provisions again allow the load on the access network to be limited since only a frame with a sufficient radio quality (i.e. a frame likely to be decoded or at least to effectively participate in the decoding of the frame by combining with other frames received by other base stations) will be transmitted by a first base station 41.

The predetermined criterion can further relate to a sequence number. For example, if a corrupted frame is received between two frames with sequence numbers N and (N+2) respectively, the corrupted frame is likely to be the frame with the sequence number (N+1), and it is worth trying to decode this frame.

The predetermined criterion can further relate to a terminal identifier. For example, if it is detected that the corrupted frame was transmitted by a terminal attributed with high importance, then it is worth trying to decode this frame.

Other criteria can be considered for triggering the transmission of a corrupted frame by the first base station 41, and the choice of a specific criterion merely constitutes an alternative implementation of the invention.

Various methods can be considered for implementing the selection 102 of the base stations 42 likely to have detected a corrupted frame corresponding to the frame to be decoded.

The selection 102 can, in particular, be based on the distance between the base stations. For example, a base station 42 is selected if the distance between said base station 42 and the first base station 41 is less than a predetermined threshold. More specifically, the base stations located in the vicinity of the first base station have a greater probability of having detected a corrupted frame corresponding to the frame to be decoded.

The selection step 102 can also be implemented by a machine learning algorithm based on a probability for a base station of having detected a corrupted frame corresponding to the frame to be decoded, knowing the first base station 41. For example, the conditional probability for a base station of having received a specific frame knowing that the first base station 41 has received said frame, a frame preceding said frame, and/or a frame following said frame, could be estimated. Using metadata accumulated in the past, a supervised machine learning model (decision tree, support vector machine (SVM), or deep learning algorithm, etc.) can be trained in order to estimate the value of this probability. The base stations with a probability value above a predetermined threshold could thus be selected, or a certain number of base stations with the highest probability values could be selected.

FIG. 4 shows a sequence chart illustrating the first implementation of the decoding method described with reference to FIGS. 2 and 3. The sequence chart illustrates the following steps of:
transmitting 201 a frame to the access network 30, using a terminal 20, the frame being detected by a first base station 40-1 and three other base stations 40-2, 40-3, 40-4,
transmitting 202 the frame detected by the first base station 41 (40-1) to the server 50,
receiving 101a, using the server 50, the corrupted frame transmitted by the first base station 41,
selecting 102 two base stations 42 (40-2 and 40-3) likely to have detected a corrupted frame corresponding to the frame to be decoded,
transmitting 103 a request to each selected base station 42 in order to request said selected base station 42 to transmit (for the first time) the possibly detected corrupted frame,
transmitting 203, using each selected base station 42, the corrupted frame detected by said base station 42,
combining 104 the corrupted frames transmitted by the various selected base stations 42 in order to decode the frame.

It should be noted that, in examples that differ from that shown in FIG. 4, a selected base station 42 may not have detected a frame corresponding to the frame to be decoded. In such a case, the base station would not respond to the request transmitted by the server.

FIG. 5 diagrammatically shows the main steps of a second implementation of the decoding method according to the invention. FIG. 6 illustrates one example implementation carried out by the access network.

In this second implementation, the method 100 comprises a step 101b wherein the server 50 determines that an expected frame should have been received on a communication channel. For example, the server 50 knows the period during which the terminal 20 transmits frames. The server can thus estimate when a frame from the terminal 20 should be received. If the server does not receive a frame from the terminal 20 at the estimated moment in time, then it is determined that an expected frame should have been received.

The method 100 then comprises a step 102 wherein the server 50 selects one or more base stations 42 likely to have detected, on said communication channel, a corrupted frame corresponding to the expected frame.

The method 100 then comprises a step 103 wherein the server 50 transmits a request to each selected base station 42 to request said selected base station 42 to transmit (for the first time) the possibly detected corrupted frame.

Finally, the server combines 104 the corrupted frames transmitted by the various selected base stations 42 in order to decode the frame.

The selection 102, transmission 103 and combination 104 steps are similar to those described for the first implementation. The second implementation thus differs from the first implementation by the way in which the method is triggered (step 101a for the first implementation and step 101b for the second implementation).

The set 43 of selected base stations 42 is shown in FIG. 6 by a dotted region.

FIG. 7 shows a sequence chart illustrating the second implementation of the decoding method described with reference to FIGS. 5 and 6. The sequence chart illustrates the following steps of:
transmitting 201 a frame to the access network 30, using a terminal 20, the frame being detected by four base stations 40-1, 40-2, 40-3, 40-4 (but none transmitting the frame to the server 50),
determining 101b, using the server 50, that an expected frame should have been received,
selecting 102 three base stations 42 (40-1, 40-2 and 40-3) likely to have detected a corrupted frame corresponding to the expected frame,
transmitting 103 a request to each selected base station 42 in order to request said selected base station 42 to transmit (for the first time) the possibly detected corrupted frame,
transmitting 203, using each selected base station 42, the corrupted frame detected by said base station 42,
combining 104 the corrupted frames transmitted by the various selected base stations 42 in order to decode the frame.

It should be noted that, in examples that differ from that shown in FIG. 7, a selected base station 42 may not have detected a frame corresponding to the expected frame. In such a case, the base station would not respond to the request transmitted by the server.

Regardless of the implementation considered, the selection step 102 can also be implemented in such a way that a base station 42 is selected if it is located in a predetermined geographical area corresponding to an estimated geographical position of the terminal 20 that transmitted the frame to be decoded. This is illustrated in FIG. 7, which shows a geographical area 70. This geographical area 70 corresponds to an estimated geographical position of the terminal 20 that transmitted the expected frame (or, in other words, the frame to be decoded). In the example considered, this geographical area 70 corresponds to a circle, the centre whereof is the estimated position of the terminal 20 and the radius whereof corresponds to a margin of error associated with the accuracy of the access network 30 when determining the position of the terminal 20.

The selection step 102 can also be implemented in such a way that a base station 42 is selected if a combination (for example an accumulation or an alternative) of the selection conditions previously described are satisfied. For example, a base station 42 is selected if it is located in the vicinity of a first base station 41 and/or if it is located in a geographical area 70 that corresponds to an estimated geographical position of the terminal 20 that transmitted the frame to be decoded.

Various methods can be used to estimate the geographical position of the terminal 20 that transmitted the frame to be decoded. For example, the terminal 20 can be equipped with a satellite positioning system and can have previously informed the access network of the geographical position thereof. In another example, the access network can have previously estimated the geographical position of the terminal 20 using multilateration methods based on the Time Difference Of Arrival (TDOA), Frequency Difference of Arrival (FDOA), or Angles of Arrival (AOA) of radio signals originating from the terminal 20. According to yet another example, the access network can have previously estimated the geographical position of the terminal 20 using classification or regression methods based on radio signatures of radio signals originating from the terminal 20 (known as radio fingerprinting). These conventional methods for estimating the position of the terminal 20 are considered to be known to those skilled in the art.

In specific implementations, in response to the request from the server, only part of the corrupted frame is transmitted by a selected base station 42, and the server 50 combines the parts of the corrupted frames transmitted by the various selected base stations 42 in order to decode the frame. Such provisions further limit the load on the access network. For example, only parts of the frame that have a quality level above a predetermined threshold are transmitted in response to the request from the server. In other words, only parts of the corrupted frame detected by a selected base station 42 that can effectively participate in decoding the frame are transmitted by said base station 42. This avoids unnecessarily transmitting frame parts whose quality is so poor that they cannot help decode the frame.

Optionally, a request transmitted by the server 50 can contain an item of information relating to a particular criterion for determining which parts of a detected corrupted frame must be transmitted in response to the request. For example, the request can specify a signal-to-noise ratio threshold, and only parts of the frame with a signal-to-noise ratio above this threshold are transmitted in response to the request. A “part” of the frame can, for example, correspond to one or more radio symbols, or to one or more data bits of the frame.

In the implementations described hereinabove, the server 50 is considered to immediately transmit a request to the selected base stations 42, i.e. as soon as the server 50 receives a corrupted frame or as soon as the server 50 determines that an expected frame should have been received. However, an accumulation period can be introduced, during which several requests intended for the same base station are accumulated within the server 50 and then included in one and the same message transmitted at the end of the accumulation period. A base station 42 that receives such a message comprising several requests can thus transmit several corrupted frames concatenated in one and the same response message. Such provisions further limit the load on the access network 30, since the number of request messages and the number of response messages is reduced.

In order to accumulate several requests to be transmitted in a single request message, or to accumulate several corrupted frames to be concatenated in a single response message, the server 50 and the base stations 40 can in particular comprise a buffer memory.

FIG. 8 illustrates, by way of example, a scenario wherein the server 50 accumulates several requests to be transmitted to various base stations over an accumulation period T_{acc}.

During the accumulation period T_{acc}, the server 50 receives, in a first step 101a, a corrupted frame A₁ transmitted (Tx) by a base station 40-1 acting as a first base station 41 for a frame A to be decoded. During the accumulation period T_{acc}, the server 50 further receives, in a second step 101a, a corrupted frame B₂ transmitted by a base station 40-2 acting as a first base station 41 for a frame B to be decoded. Moreover, during the accumulation period T_{acc}, the server 50 determines, in a step 101b, that a frame C should have been received.

At the end of the accumulation period, the server 50 implements the step 102 of selecting 50 the base stations likely to have detected corrupted frames corresponding to frames A, B and C to be decoded. In the example illustrated in FIG. 8, in step 102, the base stations 40-2 and 40-3 are selected to help decode frame A; the base stations 40-1 and 40-3 are selected to help decode frame B; the base stations 40-1, 40-2 and 40-3 are selected to help decode frame C.

Then, in step 103, instead of transmitting individual requests to each selected base station 42 for each frame to be decoded, the server 50 transmits a single request message (Req) to each selected base station 42, which request message comprises several requests intended for said base station. In the example considered, the server 50 sends the base station 40-1 a request message comprising two requests for frames B and C respectively; the server 50 sends the base station 40-2 a request message comprising two requests for frames A and C respectively; and the server 50 sends the base station 40-3 a request message comprising three requests for frames A, B and C respectively. In response, the base station 40-1 transmits a response message (Rsp) in which the corrupted frames B₁ and C₁ that it received are concatenated; the base station 40-2 transmits a response message (Rsp) in which the corrupted frames A₂ and C₂ that it received are concatenated; the base station 40-3 transmits a response message (Rsp) in which the corrupted frames A₃ and B₃ that it received are concatenated.

In step 104, the server 50 can thus combine the corrupted frames A₁, A₂ and A₃ to decode frame A; the server can combine the corrupted frames B₁, B₂ and B₃ to decode frame B; the server can combine the corrupted frames C₁ and C₂ to decode frame C.

It should be noted that, in the example illustrated in FIG. 8, the base stations 40-1 and 40-2 each detected a corrupted frame for each of the frames A, B and C. The base station 40-3, however, detected a corrupted frame for frames A and B only. The base station 40-3 is thus unable to respond to the request from the server 50 to transmit a corrupted frame corresponding to frame C.

In the implementations described hereinabove, when a base station 42 receives a request message comprising one or more requests, said base station 42 is considered to immediately transmit the one or more corrupted frames indicated in the request message. This corresponds to a synchronous operating mode wherein a response is immediately sent as soon as a request is received. However, an asynchronous operating mode can also be considered, wherein several corrupted frames which must be transmitted by a base station 42 to the server 50 are accumulated by said base station 42 during an accumulation period, and the corrupted frames are concatenated into one and the same response message transmitted by the base station 42 at the end of the accumulation period. The response message transmitted by the base station 42 can respond to several individual requests transmitted successively by the server 50 for several different frames, or to a single request message transmitted by the server 50 and comprising several requests for several different frames.

An individual request transmitted by the server 50, or a request message comprising several requests, can comprise a parameter to indicate whether the one or more requests can or must be processed synchronously or asynchronously by the base station 42. In the case that processing can or must take place asynchronously, the individual request or the request message can comprise a parameter to indicate a duration of the accumulation period or a time window in which the response must be made.

Such provisions again limit the load on the access network. More specifically, when a base station responds to several requests with a single response, the amount of data transmitted by the base station to the server is reduced because there is no need to duplicate control information in several responses (a single response comprising control information and the corrupted frames detected represents a smaller amount of data than several responses each comprising control information and a corrupted frame).

This also optimises the use of the communication channel (fewer radio resources are needed to transmit a single response comprising several concatenated corrupted frames than to transmit several responses each comprising a single corrupted frame).

Moreover, if the base station is of the half-duplex type, this limits the time during which a base station is in transmit mode and thus unavailable to receive a frame transmitted by a terminal (it takes less time to transmit a single response comprising several concatenated corrupted frames than to transmit several responses each comprising a single corrupted frame).

Rather than concatenating whole corrupted frames, parts of corrupted frames can also be concatenated (for example, in the case where only the parts of a frame that have a certain quality level need to be transmitted in response to a request from the server).

FIG. 9 illustrates, by way of example, a scenario wherein the base stations 40-1, 40-2 and 40-3 accumulate, over an accumulation period T_{acc}, several individual requests successively transmitted by the server 50 for frames A, B and C to be decoded.

The server 50 receives, in a step 101a, a corrupted frame A₁ transmitted (Tx) by the base station 40-1 acting as a first base station 41 for the frame A. The server 50 thus selects, in a step 102, the base stations 40-2 and 40-3 to help decode the frame A. The server transmits an individual request (Req) to each of the base stations 40-2 and 40-3 to request that they transmit any corrupted frame possibly received that corresponds to frame A. However, the base stations 40-2 and 40-3 do not immediately respond to the request.

The server 50 receives, in a further step 101a, a corrupted frame B₁ transmitted (Tx) by the base station 40-2 acting as a first base station 41 for the frame B. The server 50 thus selects, in a step 102, the base stations 40-1 and 40-3 to help decode the frame B. The server 50 transmits an individual request (Req) to each of the base stations 40-1 and 40-3 to request that they transmit any corrupted frame possibly received that corresponds to frame B. However, the base stations 40-1 and 40-3 do not immediately respond to the request.

Moreover, in a step 101b, the server determines that a frame C should have been received. The server 50 thus selects, in a step 102, the base stations 40-1, 40-2 and 40-3 to help decode the frame C. The server 50 transmits an individual request (Req) to each of the base stations 40-1, 40-2 and 40-3 to request that they transmit any corrupted frame possibly received that corresponds to frame C. However, the base stations 40-1, 40-2 and 40-3 do not immediately respond to the request.

At the end of the accumulation period T_{acc}, the base station 40-1 transmits a response message (Rsp) in which the corrupted frames B₁ and C₁ that it received are concatenated; the base station 40-2 transmits a response message (Rsp) in which the corrupted frames A₂ and C₂ that it received are concatenated; the base station 40-3 transmits a response message (Rsp) in which the corrupted frames A₃, B₃ that it received are concatenated. In the example considered, the base station 40-3 did not detect a corrupted frame corresponding to frame C. The base station 40-3 is thus unable to respond to the request from the server 50 to transmit a corrupted frame corresponding to frame C.

In step 104, the server 50 can thus combine the corrupted frames A₁, A₂ and A₃ to decode frame A; the server can combine the corrupted frames B₁, B₂ and B₃ to decode frame B; the server can combine the corrupted frames C₁ and C₂ to decode frame C.

The implementations described with reference to FIGS. 8 and 9 can, of course, be combined to introduce an accumulation period both on the server side and on the base station side.

The description provided hereinabove clearly shows that, via its different features and the advantages thereof, the present invention achieves the objectives set. In particular, the method 100 according to the invention allows a frame transmitted by a terminal 20 to be collaboratively decoded, which collaborative decoding involves several base stations 42, however the load on the access network 30 and the complexity at the server 50 are significantly reduced compared to conventional solutions.

Generally speaking, it should be noted that the implementations and embodiments considered hereinabove have been described by way of non-limiting examples, and that other alternative implementations and embodiments can thus be considered. In particular, various methods can be considered for selecting the base stations 42 that must participate in the collaborative decoding, or for combining the corrupted frames transmitted by these selected base stations 42. The choice of one specific method from among the various methods that can be considered merely constitutes an alternative implementation of the invention. The invention is based in particular on the fact that the selection 102 of the base stations 42 is carried out in such a way that, in order to be selected, a base station 42 does not have to communicate beforehand, to the server 50, any item of information relating to the frame to be decoded.

The invention has been described based on an example wherein a terminal 20 transmits a frame to a plurality of base stations 40 of an access network 30, and wherein a server 50 of said access network 30 is responsible for decoding the frame transmitted by the terminal 20. As mentioned hereinabove, nothing prevents the invention from being applied to other examples. The invention applies as a whole to the case where several gateway stations can receive a frame transmitted by a transmitter device and can interact with a receiver device responsible for decoding the frame.

1. A method for decoding a frame transmitted by a transmitter device of a wireless communication system, wherein said frame being may be received simultaneously by several gateway stations of said wireless communication system, said method being implemented by a receiver device connected to said gateway stations, wherein said method comprises the following steps of:
selecting one or more gateway stations likely to have detected, on a communication channel, a corrupted frame corresponding to the frame to be decoded, said selection being carried out such that, in order to be selected, a gateway station does not have to communicate beforehand, to the receiver device, any item of information relating to the possibly detected corrupted frame,
transmitting a request to each selected gateway station in order to request said selected gateway station to transmit the possibly detected corrupted frame,
combining the corrupted frames transmitted by the various selected gateway stations in order to decode the frame.

2. The method according to claim 1, comprising a prior step of receiving a corrupted frame detected on the communication channel by a first gateway station, said first gateway station being configured to transmit a corrupted frame when a predetermined criterion is satisfied.

3. The method according to claim 2, wherein the predetermined criterion for the transmission of the corrupted frame by the first gateway station is satisfied when a level of radio quality for at least part of the corrupted frame is greater than a predetermined threshold.

4. The method according to claim 2, wherein the step of selecting a gateway station likely to have detected a corrupted frame corresponding to the frame to be decoded comprises calculating a distance between said gateway station and the first gateway station.

5. The method according to claim 4, wherein the step of selecting a gateway station likely to have detected a corrupted frame corresponding to the frame to be decoded comprises comparing the distance between said gateway station and the first gateway station with a predetermined threshold.

6. The method according to claim 2, wherein the step of selecting a gateway station likely to have detected a corrupted frame corresponding to the frame to be decoded is implemented by a machine learning algorithm based on a probability for said gateway station of having detected a corrupted frame corresponding to the frame to be decoded, knowing the first gateway station.

7. The method according to claim 1, comprising a prior step of determining that an expected frame should have been received on the communication channel.

8. The method according to claim 1, wherein the step of selecting a gateway station likely to have detected a corrupted frame corresponding to the frame to be decoded comprises checking whether said gateway station is located in a predetermined geographical area corresponding to an estimated geographical position of the transmitter device that transmitted the frame to be decoded.

9. The method according to claim 1, wherein, in response to the request from the receiver device, only part of the corrupted frame is transmitted by a selected gateway station, and the receiver device combines the parts of the corrupted frames transmitted by the various selected gateway stations in order to decode the frame.

10. The method according to claim 1, wherein several requests intended for the same selected gateway station, to request said selected gateway station to transmit several different corrupted frames that may have been received, are concatenated and transmitted by the receiver device all at once in a single request message.

11. The method according to claim 1, wherein, in response to several requests transmitted by the receiver device for several different frames, several corrupted frames are concatenated and transmitted all at once by a selected gateway station.

12. A computer-readable medium comprising a set of program code instructions which, when executed by one or more processors, configure the one or more processors to implement a method according to claim 1.

13. A server of an access network of a wireless communication system, said server being connected to several base stations of said wireless communication system, said server comprising one or more processors configured to implement the method according to claim 1.

14. An access network of a wireless communication system, said access network comprising a server according to claim 13.
